(19) United States
(12) Patent Application Publication
(10) Pub. No.: US 2020/0136471 A1
(43) Pub. Date: Apr. 30, 2020

(54) COOLING SYSTEM

(71) Applicants: Nidec Corporation, Kyoto (JP); Nidec Elesys Corporation, Kawasaki-shi (JP)

(72) Inventors: Keisuke FUKUNAGA, Kyoto (JP); Yuhi NAKADA, Kyoto (JP); Satoshi SHIMAZU, Kawasaki-shi (JP)

(21) Appl. No.: 16/656,890

(22) Filed: Oct. 18, 2019

(30) Foreign Application Priority Data
Oct. 26, 2018 (JP) 2018-201981

(51) Int. Cl. H02K 9/193; H02K 11/25; H02K 11/33

(52) U.S. Cl. CPC H02K 9/193; H02K 11/33; H02K 11/25

(57) ABSTRACT

A cooling system includes a coolant circulation flow path, a motor thermometer, an inverter thermometer, and a controller connected to the motor thermometer and the inverter thermometer. An oil cooler that cools oil supplied to the motor, the inverter that supplies electric power to the motor, a radiator that cools the coolant, and a coolant pump that pumps the coolant are arranged in series in a channel of the coolant circulation flow path. The controller executes a first step of calculating a drive output of the coolant pump based on the temperature of the motor, a second step of calculating a drive output of the coolant pump based on the temperature of the inverter, and a third step of selecting one of a calculation result of the first and second step having a larger drive output to drive the coolant pump.

### CROSS REFERENCE TO RELATED APPLICATION

The present application claims priority under 35 U.S.C. § 119 to Japanese Application No. 2018-201981 filed on Oct. 26, 2018 the entire contents of which are hereby incorporated herein by reference.

### 1. FIELD OF THE INVENTION

The present disclosure relates to a cooling system.

### 2. BACKGROUND

An electric vehicle or a hybrid electric vehicle is required to be equipped with a cooling system that cools a motor and an inverter. A cooling device having a coolant circulation flow path that supplies coolant to an inverter and a motor is known. The coolant circulation flow path is provided with a radiator that cools the coolant and a pump that pumps the coolant.

In a conventional coolant circulation flow path, a cooling device is controlled according to a temperature of an inverter.

The inverter has a small heat capacity and is subject to a rapid temperature change. In addition, a motor has a larger heat capacity than the inverter. Therefore, when the cooling device is controlled in accordance with the temperature of the inverter, there is a concern that the motor whose temperature gradually rises may be insufficiently cooled.

### SUMMARY

A cooling system according to an example embodiment of the present disclosure includes a coolant circulation flow path through which coolant circulates, a motor thermometer which measures a temperature of a motor, an inverter thermometer which measures a temperature of an inverter, and a controller connected to the motor thermometer and the inverter thermometer. An oil cooler which cools oil to be supplied to the motor, the inverter which supplies electric power to the motor, a radiator which cools the coolant, and a coolant pump which pumps the coolant are arranged in series in a channel of the coolant circulation flow path. The controller executes a first step of calculating a drive output of the coolant pump based on the temperature of the motor, a second step of calculating a drive output of the coolant pump based on the temperature of the inverter, and a third step of selecting one of a calculation results of the first step and a calculation result of the second step that has a larger drive output to drive the coolant pump.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a conceptual diagram of a cooling system and a motor assembly cooled by the cooling system according to an example embodiment of the present disclosure.

FIG. 2 is a flowchart illustrating steps executed by a controller according to an example embodiment of the present disclosure.

FIG. 3 is a graph illustrating a relationship between a motor temperature and a motor reference output in a first step S1 according to an example embodiment of the present disclosure.

FIG. 4 is a graph illustrating a relationship between the motor temperature and an inverter reference output in a second step S2 according to an example embodiment of the present disclosure.

FIG. 5 is a graph illustrating a relationship between a motor temperature and an inverter reference output in a second step S2 according to a modification of an example embodiment of the present disclosure.

### DETAILED DESCRIPTION

Hereinafter, cooling systems according to example embodiments of the present disclosure will be described with reference to the drawings.

Note that the scope of the present disclosure is not limited to the example embodiments described below, but includes any modification within the scope of the technical idea of the present disclosure. In addition, there is a case where scales, numbers, and the like of structures illustrated in the following drawings may differ from those of actual structures, for the sake of easier understanding of the structures.

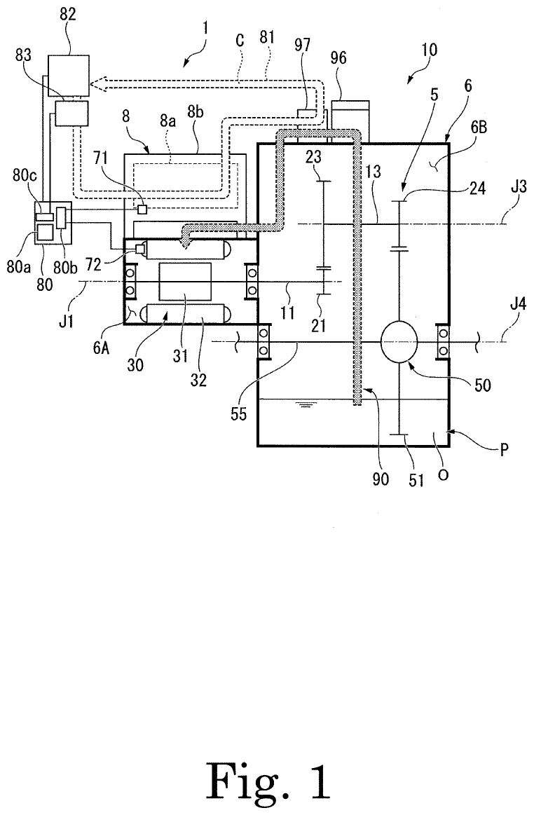

FIG. 1 is a conceptual diagram of a cooling system 1 and a motor assembly 10 cooled by the cooling system 1 according to the example embodiment. Note that a motor axis J1, a counter axis J3, and an output axis J4, which will be described later, are virtual axes that do not actually exist.

The motor assembly 10 is mounted on a vehicle and drives the vehicle by rotating wheels. The motor assembly 10 is mounted on, for example, an electric vehicle (EV). Note that it is sufficient for the motor assembly 10 to be mounted on a vehicle using a motor as a motive power source, such as a hybrid electric vehicle (HEV) and a plug-in hybrid electric vehicle (PHV).

As illustrated in FIG. 1, the motor assembly 10 includes a motor 30, a transmission mechanism (transaxle) 5, a housing 6, an oil pump 96, an oil cooler 97, oil O, and an inverter unit 8.

The motor 30 is a motor generator that has both a function as an electric motor and a function as a generator. The motor 30 mainly functions as the electric motor to drive the vehicle, and functions as the generator during regeneration.

The motor 30 includes a rotor 31 and a stator 32 that surrounds the rotor 31. The rotor 31 can rotate about the motor axis J1. The rotor 31 is fixed to a motor drive shaft 11 to be described later. The rotor 31 rotates about the motor axis J1.

The motor 30 is connected to an inverter 8a. The inverter 8a converts a direct current supplied from a battery (not illustrated) into an alternating current and supplies the alternating current to the motor 30. Each rotational speed of the motor 30 is controlled by controlling the inverter 8a.

The transmission mechanism 5 transmits motive power of the motor 30 and outputs the motive power from output shafts 55. The transmission mechanism 5 incorporates a plurality of mechanisms responsible for motive power transmission between a drive source and a driven device.

The transmission mechanism 5 includes a motor drive shaft 11, a motor drive gear 21, a counter shaft 13, a counter gear (large gear) 23, a drive gear (small gear) 24, a ring gear 51, the output shafts (axles) 55, and a differential device (differential gear) 50.

The motor drive shaft 11 extends along the motor axis J1. The motor drive shaft 11 is rotated by the motor 30. The motor drive gear 21 is fixed to the motor drive shaft 11. The motor drive gear 21 meshes with the counter gear 23.

The counter gear 23 extends along the counter axis J3 and is fixed to the counter shaft 13. The drive gear 24 as well as the counter gear 23 is fixed to the counter shaft 13.

The drive gear 24 meshes with the ring gear 51.

The ring gear 51 is fixed to the differential device 50. The ring gear 51 rotates about the output axis J4. The ring gear 51 transmits the motive power of motor 30 transmitted via drive gear 24 to the differential device 50.

The differential device 50 is a device configured to transmit a torque output from the motor 30 to wheels of the vehicle. The differential device 50 is connected to the pair of output shafts 55. The wheel is attached to each of the pair of output shafts 55. The differential device 50 has a function of transmitting the same torque to the pair of output shafts 55 while absorbing a speed difference between the left and right wheels when the vehicle turns.

The inverter unit 8 is fixed to an outer surface of the housing 6 in an inverter case 8b. The inverter unit 8 includes an inverter 8a and the inverter case 8b that accommodates the inverter 8a. Although not illustrated, the inverter unit 8 further includes a circuit board and a capacitor.

The inverter 8a is connected to the motor 30 via a bus bar (not illustrated). The inverter 8a supplies an alternating current to the motor 30 via the bus bar. As a result, the inverter unit 8 supplies electric power to the motor 30.

The housing 6 accommodates the motor 30 and the transmission mechanism 5. The interior of the housing 6 is partitioned into a motor chamber 6A that accommodates the motor 30 and a gear chamber 6B that accommodates the transmission mechanism 5.

The oil O accumulates inside the housing. In addition, the oil O circulates through an oil passage 90 provided in the housing 6. The oil O is used to lubricate the transmission mechanism 5 and used to cool the motor 30. The oil O accumulates in a lower region (that is, oil reservoir P) of the gear chamber 6B. A part of the transmission mechanism 5 is immersed in the oil of the oil reservoir P. The oil O accumulated in the oil reservoir P is pumped up by an operation of the transmission mechanism 5 and diffused into the gear chamber 6B. The oil O diffused into the gear chamber 6B is supplied to each gear of the transmission mechanism 5 in the gear chamber 6B and spreads the oil O on a gear tooth surface.

The oil passage 90 is provided in the housing 6. The oil passage 90 is configured to straddle the motor chamber 6A and the gear chamber 6B. The oil pump 96 and the oil cooler 97 are provided in the oil passage 90. In the oil passage 90, the oil O circulates in the order of the oil reservoir P, the oil pump 96, the oil cooler 97, and the motor 30, and returns to the oil reservoir P.

The oil pump 96 is provided in a channel of the oil passage 90 and pumps the oil O. The oil pump 96 is an electric pump that is driven by electricity. The oil pump 96 sucks up the oil O from the oil reservoir P. The oil pump 96 supplies the sucked oil O to the motor 30 via the oil cooler 97.

The oil cooler 97 is provided in the channel of the oil passage 90 and cools the oil O passing through the oil passage 90. That is, the oil cooler 97 cools the oil O supplied to the motor 30. The oil cooler 97 is fixed to a gear accommodating portion 63 of the housing 6. A circulation flow path 81 of the cooling system 1 is connected to the oil cooler 97. The oil O passing through the oil cooler 97 is cooled by heat exchange with coolant C passing through the circulation flow path 81. That is, the coolant C cools the motor 30 via the oil cooler 97 and the oil O.

The oil O that has passed through the oil cooler 97 is supplied to the motor 30 via a flow path provided in the housing 6 above the motor chamber 6A. The oil O supplied to the motor 30 flows along an outer peripheral surface of the motor 30 and a coil surface of the stator 32 from the upper side to the lower side, and takes the heat of the motor 30. As a result, the entire motor can be cooled. The oil O that has cooled the motor 30 is dropped to the lower side and accumulates in the lower region in the motor chamber 6A. The oil O accumulating in the lower region in the motor chamber 6A moves to the gear chamber 6B through an opening (not illustrated).

The cooling system 1 includes a coolant circulation flow path 81 (hereinafter simply referred to as a circulation flow path), a motor thermometer 72, an inverter thermometer 71, and a controller 80.

The coolant C circulates in the circulation flow path 81. The circulation flow path 81 is an annular flow path having no branch. The oil cooler 97, the inverter 8a, a radiator 82, and a coolant pump 83 are arranged in series in the channel of the circulation flow path 81. The oil cooler 97 and the inverter 8a are cooled by the coolant C. The radiator 82 cools the coolant C. The coolant pump 83 pumps the coolant C in the circulation flow path 81.

Note that the radiator 82 and the coolant pump 83 can also be regarded as a part of the cooling system 1. In this case, the cooling system 1 includes the radiator 82 and the coolant pump 83.

The motor thermometer 72 measures a temperature of the motor 30. The motor thermometer 72 is attached to a coil end of the stator 32 of the motor 30. Therefore, the motor thermometer 72 outputs a coil temperature as the temperature of the motor 30. In the present specification, a measurement result of the motor temperature output from the motor thermometer 72 will be described as a motor temperature Tm.

The inverter thermometer 71 measures a temperature of the inverter 8a. The inverter 8a is attached to a terminal portion of the inverter 8a. Therefore, the inverter thermometer outputs a temperature of the terminal portion of the inverter 8a as the temperature of the inverter 8a. In the present specification, a measurement result of the inverter temperature output from the inverter thermometer 71 will be described as an inverter temperature Ti.

The controller 80 is connected to the motor thermometer 72, the inverter thermometer 71, the radiator 82, and the coolant pump 83. The controller 80 controls the coolant pump 83 based on the motor temperature Tm and the inverter temperature Ti. Although a connection line is not illustrated, the controller 80 of the example embodiment is connected to the oil pump 96.

The controller 80 may be a part of a vehicle control device (for example, ECU: Engine Controller).

The controller 80 includes a calculation unit 80a, a sensor interface 80b, and a pump interface 80c. The sensor interface 80b is connected to the motor thermometer 72 and the inverter thermometer 71. The pump interface 80c is connected to the coolant pump 83. The calculation unit 80a acquires the motor temperature Tm and the inverter temperature Ti via the sensor interface 80b. The calculation unit 80a calculates an appropriate drive output of the coolant pump 83 based on the acquired motor temperature Tm and inverter temperature Ti. The pump interface 80c drives the coolant pump 83 with the drive output calculated by the calculation unit 80a.

The drive output of the coolant pump 83 controlled by the controller 80 is, for example, a flow rate of the coolant C pumped by the coolant pump 83.

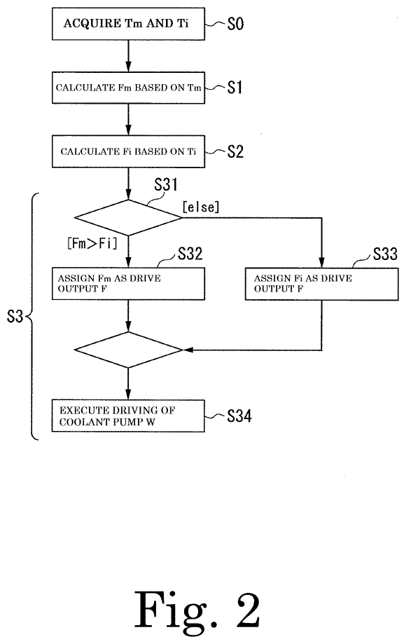

FIG. 2 is a flowchart illustrating steps executed by the controller 80. The controller 80 executes a preliminary step S0, a first step S1, a second step S2, and a third step S3. In FIG. 2, the order of the first step S1 and the second step S2 may be reversed.

In the preliminary step S0, the controller 80 acquires the motor temperature Tm from the motor thermometer 72 and acquires the inverter temperature Ti from the inverter thermometer 71.

In the first step S1, the controller 80 calculates the drive output of the coolant pump 83 based on the motor temperature Tm. In the present specification, the drive output of the coolant pump 83 based on the motor temperature Tm is referred to as a motor reference output Fm. That is, the controller 80 calculates the motor reference output Fm in the first step S1.

In the second step S2, the controller 80 calculates the drive output of the coolant pump 83 based on the inverter temperature Ti. In the present specification, the drive output of the coolant pump 83 based on the inverter temperature Ti is referred to as an inverter reference output Fi. That is, the controller 80 calculates the inverter reference output Fi in the second step S2.

The controller 80 determines an actual drive output F of the coolant pump 83 in the third step S3. In the third step S3, the controller 80 selects one of the calculation result of the first step S1 and the calculation result of the second step S2 having a larger drive output to drive the coolant pump 83.

More specifically, in the third step S3, the controller 80 first compares the motor reference output Fm calculated in the first step S1 with the inverter reference output Fi calculated in the second step S2 (Step S31). When the motor reference output Fm is larger than the inverter reference output Fi (Fm>Fi), the motor reference output Fm is assigned as the drive output F of the coolant pump 83 (Step S32). When the inverter reference output Fi is equal to or larger than the motor reference output Fm (Fi≥Fm), the inverter reference output Fi is assigned as the drive output F of the coolant pump 83 (Step S33). Further, the coolant pump 83 is driven with the assigned drive output F (Step S34).

According to the cooling system 1 of the example embodiment, the motor reference output Fm based on the motor temperature Tm and the inverter reference output Fi based on the inverter temperature Ti are calculated, and the coolant pump 83 is driven with one drive output having a larger value. Thus, the cooling system 1 can cool the inverter 8a and the motor 30 in response to a temperature change of the inverter 8a and a temperature change of the motor 30. As a result, even when the oil cooler 97 and the inverter 8a are arranged in series in the circulation flow path 81, the oil cooler 97 and the inverter 8a can be efficiently cooled.

Note that values of the motor reference output Fm calculated in the first step S1 and the inverter reference output Fi calculated in the second step S2 may be zero in the example embodiment. When both the values of the motor reference output Fm and the inverter reference output Fi are zero, zero is assigned as the drive output F of the coolant pump 83, and the coolant pump 83 is not driven. As an example, there is a case where it is unnecessary to cool the motor 30 and the inverter 8a even when the motor 30 is driven in a cold area or the like where the temperature is sufficiently low. According to the example embodiment, it is possible to suppress the driving of the coolant pump 83 at a timing that does not require cooling to suppress power consumption.

In the example embodiment, the controller 80 drives the coolant pump when the oil pump 96 is driven, separately from the above-described flow of the preliminary step S0 to the third step S3. When the oil pump 96 is driven, the oil O is supplied to the motor 30. Since the coolant pump 83 is driven when the oil pump 96 is driven, the oil O cooled by the coolant C can be supplied to the motor 30.

Next, a method for calculating the motor reference output Fm in the first step S1 will be described more specifically.

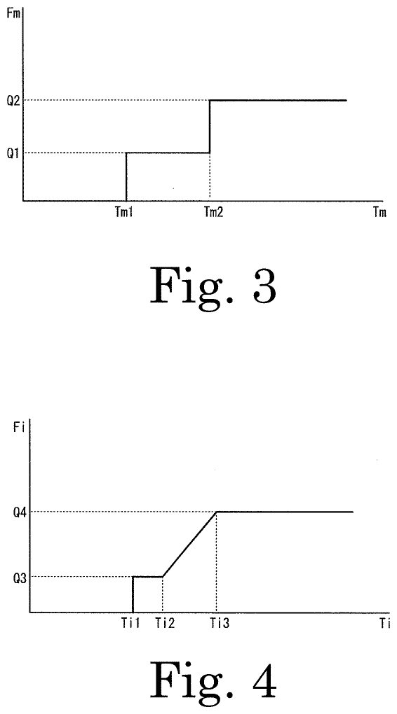

FIG. 3 is a graph illustrating a relationship between the motor temperature Tm and the motor reference output Fm calculated in the first step S1.

The controller 80 calculates a positive value as the motor reference output Fm when the motor temperature Tm becomes equal to or higher than a first motor temperature Tm1. That is, the controller 80 drives the coolant pump 83 when the motor temperature Tm is equal to or higher than the first motor temperature Tm1.

The first motor temperature Tm1 is a temperature preset in the controller 80. As the first motor temperature Tm1, for example, the lowest temperature that is considered necessary to start cooling of the motor 30 is set.

The controller 80 calculates a first drive output Q1 as the motor reference output Fm when the motor temperature Tm is equal to or higher than the first motor temperature Tm1 and lower than a second motor temperature Tm2. Therefore, when the inverter temperature Ti is sufficiently low, the controller 80 drives the coolant pump 83 with a constant drive output (first drive output Q1) in a range of the motor temperature Tm. In addition, the controller 80 drives the coolant pump 83 with a drive output equal to or higher than the first drive output Q1 regardless of the inverter temperature Ti in the range of the motor temperature Tm. Thus, it is possible to prevent insufficient cooling of the motor 30.

The first drive output Q1 is a drive output preset in the controller 80. As the first drive output Q1, for example, a drive output of the coolant pump 83, which can suppress a temperature rise of the motor 30 when the motor 30 is driven with an average load, is set.

The controller 80 calculates a drive output larger than the first drive output Q1 as the motor reference output Fm when the motor temperature Tm is equal to or higher than the second motor temperature Tm2. Therefore, if the inverter temperature Ti is sufficiently low, the controller 80 increases the drive output of the coolant pump 83 when the motor temperature Tm becomes equal to or higher than the second motor temperature Tm2, thereby enhancing the cooling efficiency of the motor 30.

The second motor temperature Tm2 is a temperature preset in the controller 80. As the second motor temperature Tm2, for example, a temperature, obtained by adding a safety factor to a temperature at which deterioration of the function of the motor 30 is concerned, is set.

The controller 80 calculates the second drive output Q2 as the motor reference output Fm when the motor temperature Tm is equal to or higher than the second motor temperature Tm2. Therefore, when the motor temperature Tm is equal to or higher than the second motor temperature Tm2, the controller 80 drives the coolant pump 83 with the drive output of the second drive output Q2 regardless of the inverter temperature Ti.

The second drive output Q2 is a drive output preset in the controller 80. For example, the maximum output of the coolant pump 83 is set as the second drive output Q2.

According to the example embodiment, the controller 80 raises and lowers the drive output of the coolant pump 83 in a stepwise manner based on the motor temperature Tm. Since the motor 30 has a relatively high heat capacity, the temperature rises and falls gradually with heat generation. The cooling system 1 raises and lowers the drive output of the coolant pump 83 in a stepwise manner, and thus, can sufficiently cool the motor 30 while suppressing the power consumption of the coolant pump 83.

Next, a method for calculating the inverter reference output Fi in the second step S2 will be described more specifically.

FIG. 4 is a graph illustrating a relationship between the inverter temperature Ti and the inverter reference output Fi calculated in the second step S2.

The controller 80 calculates a positive value as the inverter reference output Fi when the inverter temperature Ti becomes equal to or higher than a first inverter temperature Ti1. That is, the controller 80 drives the coolant pump 83 when the inverter temperature Ti is equal to or higher than the first inverter temperature Ti1.

The first inverter temperature Ti1 is a temperature preset in the controller 80. As the first inverter temperature Ti1, for example, the lowest temperature that is considered necessary to start cooling the inverter 8a is set.

The controller 80 calculates a third drive output Q3 as the inverter reference output Fi when the inverter temperature Ti is equal to or higher than the first inverter temperature Ti1 and lower than a second inverter temperature Ti2. Therefore, when the motor temperature Tm is sufficiently low, the controller 80 drives the coolant pump 83 with a constant drive output (third drive output Q3) in a range of the inverter temperature Ti. In addition, the controller 80 drives the coolant pump 83 with a drive output equal to or higher than the third drive output Q3 regardless of the motor temperature Tm in the range of the inverter temperature Ti. Thus, it is possible to prevent insufficient cooling of the inverter 8a.

The third drive output Q3 is a drive output preset in the controller 80. As the third drive output Q3, for example, a drive output of the coolant pump 83, which can suppress a temperature rise of the inverter 8a when the inverter 8a operates with an average load, is set. Note that the third drive output Q3 may coincide with the first drive output Q1.

When the inverter temperature Ti is equal to or higher than the second inverter temperature Ti2, the controller 80 calculates a drive output larger than the third drive output Q3 as the inverter reference output Fi. Therefore, when the motor temperature Tm is sufficiently low, the controller 80 increases the drive output of the coolant pump 83 when the inverter temperature Ti becomes equal to or higher than the second inverter temperature Ti2, thereby enhancing the cooling efficiency of the inverter 8a.

The second inverter temperature Ti2 is a temperature preset in the controller 80. As the second inverter temperature Ti2, for example, a temperature, obtained by adding a safety factor to a temperature at which deterioration of the function of the inverter 8a is concerned, is set.

When the inverter temperature Ti is equal to or higher than the second inverter temperature Ti2 and lower than a third inverter temperature Ti3, the controller 80 calculates a drive output that is increased in proportion to a temperature of the inverter temperature Ti as the inverter reference output Fi. Therefore, the controller 80 changes the inverter reference output Fi based on the inverter temperature Ti in the range of the inverter temperature Ti.

The controller 80 calculates a fourth drive output Q4 as the inverter reference output Fi when the inverter temperature Ti is equal to or higher than the third inverter temperature Ti3. Therefore, when the inverter temperature Ti is equal to or higher than the third inverter temperature Ti3, the controller 80 drives the coolant pump 83 with the drive output of the fourth drive output Q4 regardless of the motor temperature Tm.

The third inverter temperature Ti3 is a temperature preset in the controller 80. As the third inverter temperature Ti3, for example, a temperature, obtained by adding a sufficient safety factor to a temperature at which deterioration of the inverter 8a is concerned, is set. In addition, the fourth drive output Q4 is a drive output preset in the controller 80. For example, the maximum output of the coolant pump 83 is set as the fourth drive output Q4.

According to the example embodiment, the controller 80 increases and decreases the drive output of the coolant pump 83 in a linear function based on the inverter temperature Ti. Since the inverter 8a has a relatively low heat capacity, the temperature rises and falls sensitive to heat generation. The cooling system 1 can cool the inverter 8a against a sudden temperature change by increasing and decreasing the drive output of the coolant pump 83 in a linear function.

In the example embodiment, thresholds of the motor temperature Tm and the inverter temperature Ti have the following relationship. The second motor temperature Tm2 is higher than the first motor temperature Tm1. The third inverter temperature Ti3 is higher than the second inverter temperature Ti2. The second inverter temperature Ti2 is higher than the first inverter temperature Ti1. In addition, it is not important which one is higher between each of the first motor temperature Tm1 and the second motor temperature Tm2 and each of the first inverter temperature Ti1, the second inverter temperature Ti2, and the third inverter temperature Ti3.

A method for calculating an inverter reference output Fi in a second step S2 according to a modification will be described.

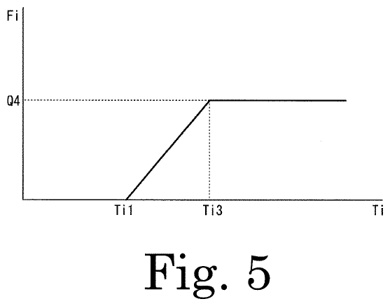

FIG. 5 is a graph illustrating a relationship between an inverter temperature Ti and the inverter reference output Fi calculated in the second step S2 according to the modification.

The controller 80 calculates a positive value as the inverter reference output Fi when the inverter temperature Ti becomes equal to or higher than a first inverter temperature Ti1. When the inverter temperature Ti is equal to or higher than the first inverter temperature Ti1 and lower than a third inverter temperature Ti3, the controller 80 calculates a drive output that is increased in proportion to a temperature of the inverter temperature Ti as the inverter reference output Fi. As illustrated in the modification, such a calculation method may be applied in the second step S2.

Although the example embodiment and modification of the present disclosure have been described above, the configurations described in the example embodiment and modification and the combinations of the configurations are merely examples, and thus, addition, omission, substation and other alterations may be appropriately made within the scope of the present disclosure. In addition, the disclosure is not to be limited by the example embodiment.

For example, the description has been given in the above-described example embodiment regarding the case in which the drive output of the coolant pump is increased in a stepwise manner relative to the motor temperature, and the drive output of the coolant pump is increased in a linear function (linearly) relative to the inverter temperature. However, the drive output of the coolant pump may be increased in a linear function relative to the motor temperature, or the drive output of the coolant pump may be increased in a stepwise manner relative to the inverter temperature.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A cooling system comprising:
a coolant circulation flow path through which coolant circulates;
a motor thermometer that measures a temperature of a motor;
an inverter thermometer that measures a temperature of an inverter; and
a controller connected to the motor thermometer and the inverter thermometer; wherein
an oil cooler that cools oil supplied to the motor, the inverter that supplies electric power to the motor, a radiator that cools the coolant, and a coolant pump that pumps the coolant are arranged in series in a channel of the coolant circulation flow path; and
the controller executes:
a first step of calculating a drive output of the coolant pump based on the temperature of the motor;
a second step of calculating a drive output of the coolant pump based on the temperature of the inverter; and
a third step of selecting one of a calculation result of the first step and a calculation result of the second step having a larger drive output to drive the coolant pump.

2. The cooling system according to claim 1, wherein in the first step:
a first drive output is calculated when the temperature of the motor is equal to or higher than a first motor temperature and lower than a second motor temperature; and
a drive output greater than the first drive output is calculated when the temperature of the motor is equal to or higher than the second motor temperature.

3. The cooling system according to claim 2, wherein in the first step, a second drive output is calculated when the temperature of the motor is equal to or higher than the second motor temperature.

4. The cooling system according to claim 1, wherein in the second step:
a third drive output is calculated when the temperature of the inverter is equal to or higher than a first inverter temperature and lower than a second inverter temperature; and
a drive output greater than the third drive output is calculated when the temperature of the inverter is equal to or higher than the second inverter temperature.

5. The cooling system according to claim 4, wherein in the second step, a drive output that is increased in proportion to the temperature of the inverter is calculated when the temperature of the inverter is equal to or higher than the second inverter temperature and lower than a third inverter temperature.

6. The cooling system according to claim 1, wherein in the second step, a drive output that is increased in proportion to the temperature of the inverter is calculated when the temperature of the inverter is equal to or higher than the first inverter temperature and lower than a third inverter temperature.

7. The cooling system according to claim 5, wherein in the second step, a fourth drive output is calculated when the temperature of the inverter is equal to or higher than the third inverter temperature.

8. The cooling system according to claim 6, wherein in the second step, a fourth drive output is calculated when the temperature of the inverter is equal to or higher than the third inverter temperature.

9. The cooling system according to claim 1, wherein
the controller is connected to an oil pump that supplies the oil to the motor; and
the controller drives the coolant pump when the oil pump is driven.

10. The cooling system according to claim 1, wherein
the motor is accommodated in a housing; and
the inverter is fixed to the housing.
